(19) United States
(12) Patent Application Publication
(10) Pub. No.: US 2025/0238832 A1
(43) Pub. Date: Jul. 24, 2025

(54) SYSTEM AND METHOD

(71) Applicant: BOOTROCK INC., Tokyo (JP)

(72) Inventors: Jinya TAKAHASHI, Tokyo (JP); Masahiko ISO, Tokyo (JP); Masakazu OKANO, Tokyo (JP); Hisayoshi SASAKI, Tokyo (JP); Yu TORITSUKA, Tokyo (JP); Hitoshi YAKUWA, Tokyo (JP); Yasufumi HATTORI, Tokyo (JP)

(73) Assignee: BOOTROCK INC., Tokyo (JP)

(21) Appl. No.: 18/855,506

(22) PCT Filed: Apr. 18, 2023
(86) PCT No.: PCT/JP2023/015451

§ 371 Date: Oct. 9, 2024

(30) Foreign Application Priority Data
Apr. 18, 2022 (JP) 2022-068544

(51) Int. Cl. G06Q 30/0207; G06Q 30/018

(52) U.S. Cl. CPC G06Q 30/0212; G06Q 30/018

(57) ABSTRACT

A present invention provides a system capable of setting a product obtained by combining content and benefit. A system had at least one computer apparatus, the system including: a content information storage that stores at least one piece of content information; a benefit information storage that stores at least one piece of benefit information; a content information selector that receives selection of the at least one piece of content information stored in the content information storage by an operation on a first user terminal operated by a first user; a benefit information selector that receives selection of the at least one piece of benefit information stored in the benefit information storage by an operation on the first user terminal; and a product information generator that generates product information capable of specifying a combination of the selection-received content information and the selection-received benefit information.

### TECHNICAL FIELD

The present invention relates to a system and a method related to a product including content information such as music and benefit information.

### BACKGROUND ART

In recent years, products are sold in which content such as a CD has additional value (benefit) such as an admission ticket or a benefit ticket for an event such as a live show. In addition, such content is sold through the Internet.

### SUMMARY OF INVENTION

### Technical Problem

A first object of the present invention is to provide a system capable of setting a product obtained by combining content and benefit. In addition, a second object of the present invention is to provide a system capable of controlling a result of a lottery so that a predetermined benefit is not granted or is unlikely to be granted to some users. A third object of the present invention is to provide a novel system regarding selling of products.

### Solution to Problem

The objects of the present invention are achieved by providing the following:
[1] A system comprising at least one computer apparatus, the system comprising: a content information storage that stores at least one piece of content information; a benefit information storage that stores at least one piece of benefit information; a content information selector that receives selection of the at least one piece of content information stored in the content information storage by an operation on a first user terminal operated by a first user; a benefit information selector that receives selection of the at least one piece of benefit information stored in the benefit information storage by an operation on the first user terminal; and a product information generator that generates product information capable of specifying a combination of the selection-received content information and the selection-received benefit information;
[2] The system according to the [1], comprising a product information transmitter that transmits the content information and the benefit information specified by the generated product information to a second user terminal operated by a second user by an operation on the second user terminal;
[3] The system according to the [1] or [2], comprising a benefit information generator that generates benefit information by an operation on the first user terminal, wherein the benefit information storage stores the generated benefit information;
[4] The system according to any one of the [1] to [3], wherein the product information generator generates a plurality of pieces of product information capable of specifying a combination of one piece of content information with each of different types and/or different numbers of pieces of benefit information;
[5] The system according to any one of the [1] to [4], wherein the content information is music information, audio information, image information, moving image information, and/or character information;
[6] The system according to any one of the [1] to [6], wherein the benefit information is information regarding an admission ticket or a benefit ticket for an event regarding the content information, information regarding merchandise regarding the content information, and/or audio information, moving image information, or image information regarding the content information;
[7] The system according to any one of the [1] to [6], wherein the benefit information includes lottery information for drawing a benefit to be granted to the second user;
[8] The system according to the [7], wherein the lottery information enables a lottery to be drawn according to the number of times of purchasing a product including a combination of the content information and the benefit information, an amount of money of purchasing the product, and/or a combination of purchased products;
[9] A method executed in a system including at least one computer apparatus, the method comprising: a content information storage step of storing at least one piece of content information; a benefit information storage step of storing at least one piece of benefit information; a content information selection step of receiving selection of the at least one piece of content information stored in the content information storage step by an operation on a first user terminal operated by a first user; a benefit information selection step of receiving selection of the at least one piece of benefit information stored in the benefit information storage step by an operation on the first user terminal; and a product information generation step of generating product information capable of specifying a product including a combination of the selection-received content information and the selection-received benefit information;
[10] A system comprising at least one computer apparatus, the system comprising: a user specifier that specifies a certain second user among a plurality of second users according to an operation on a first user terminal operated by a first user; and a lottery executer that executes a lottery for granting a benefit to a second user, wherein the lottery executer controls a result of the lottery so as not to grant a predetermined benefit to the specified second user, or executes the lottery so as to reduce a probability of granting a predetermined benefit to the specified second user;
[11] A method executed in a system including at least one computer apparatus, the method comprising: a user specification step of specifying a certain second user among a plurality of second users according to an operation on a first user terminal operated by a first user; and a lottery execution step of executing a lottery for granting a benefit to a second user, wherein the lottery execution step controls a result of the lottery so as not to grant a predetermined benefit to the specified second user, or executes the lottery so as to reduce a probability of granting a predetermined benefit to the specified second user;
[12] A system comprising a first system including at least one computer apparatus, and a second system including at least one computer apparatus, the first system including an identification information transmitter that transmits user identification information capable of identifying a user or a user terminal and product identification information capable of identifying a product to the second system in association with each other according to an operation on the user terminal operated by the user, and the second system including an identification information receiver that receives the user identification information and the product identification information, and a product information transmitter that transmits product information corresponding to the product identification information associated with the user identification information to the user terminal operated by the user corresponding to the received user identification information or the user terminal corresponding to the received user identification information;
[13] The system according to the [12], comprising a plurality of the first systems;
[14] A method executed in a system including a first system including at least one computer apparatus, and a second system including at least one computer apparatus, the method comprising: an identification information transmission step of transmitting user identification information capable of identifying a user or a user terminal and product identification information capable of identifying a product to the second system in association with each other according to an operation on the user terminal operated by the user in the first system; an identification information step of receiving the user identification information and the product identification information in the second system; and a product information transmission step of transmitting product information corresponding to the product identification information associated with the user identification information to the user terminal operated by the user corresponding to the received user identification information or the user terminal corresponding to the received user identification information in the second system;
[15] A system comprising at least one computer apparatus, the system comprising: an identification information receiver that receives user identification information capable of identifying a user or a user terminal and product identification information capable of identifying a product in association with each other according to an operation on the user terminal; and a product information transmitter that transmits product information corresponding to the product identification information associated with the user identification information to the user terminal operated by the user corresponding to the received user identification information or the user terminal corresponding to the received user identification information;
[16] A method executed in a system including at least one computer apparatus, the method comprising: an identification information reception step of receiving user identification information capable of identifying a user or a user terminal and product identification information capable of identifying a product in association with each other according to an operation on the user terminal;

and a product information transmission step of transmitting product information corresponding to the product identification information associated with the user identification information to the user terminal operated by the user corresponding to the received user identification information or the user terminal corresponding to the received user identification information.

### Advantageous Effects of Invention

According to the present invention, it is possible to provide a system capable of setting a product obtained by combining content and benefit. In addition, it is possible to provide a system capable of controlling a result of a lottery so that a predetermined benefit is not granted or is unlikely to be granted to some users. In addition, it is possible to provide a novel system regarding selling of products.

### BRIEF DESCRIPTION OF DRAWINGS

FIG. 1 is a block diagram illustrating a configuration of a sales system according to an embodiment of the present invention.

FIG. 2 is a block diagram illustrating a configuration of an administrator terminal according to an embodiment of the present invention.

FIG. 3 is a block diagram illustrating a configuration of a content server according to an embodiment of the present invention.

FIG. 4 is a diagram illustrating a flowchart of a product setting processing according to the embodiment of the present invention.

FIG. 5 is a diagram illustrating a flowchart of a content information setting processing according to the embodiment of the present invention.

FIG. 6 is a diagram illustrating a flowchart of a benefit information setting processing according to the embodiment of the present invention.

FIG. 7 is a diagram illustrating a sales project design according to the embodiment of the present invention.

FIG. 8 is a diagram illustrating an example of a display screen of the administrator terminal according to the embodiment of the present invention.

FIG. 9 is a diagram illustrating an example of the display screen of the administrator terminal according to the embodiment of the present invention.

FIG. 10 is a diagram illustrating an example of the display screen of the administrator terminal according to the embodiment of the present invention.

FIG. 11 is a diagram illustrating an example of the display screen of the administrator terminal according to the embodiment of the present invention.

FIG. 12 is a diagram illustrating an example of the display screen of the administrator terminal according to the embodiment of the present invention.

FIG. 13 is a diagram illustrating the processing flow of the sales system according to the embodiment of the present invention.

### DESCRIPTION OF EMBODIMENTS

Hereinafter, embodiments of the invention will be described. The invention, however, is not limited to the following embodiments without departing from the spirit of the invention. Hereinafter, description relating to effects shows an aspect of the effects of the embodiments of the invention and does not limit the effects. The order of the processes constituting the flow charts described below is a random order within the range that does not cause inconsistencies and discrepancies in the process substances. Moreover, within the range that does not cause inconsistencies and discrepancies in the process substances, part of the processes constituting the flow charts can be omitted, and/or a new process(es) can be added to the processes constituting the flow charts.

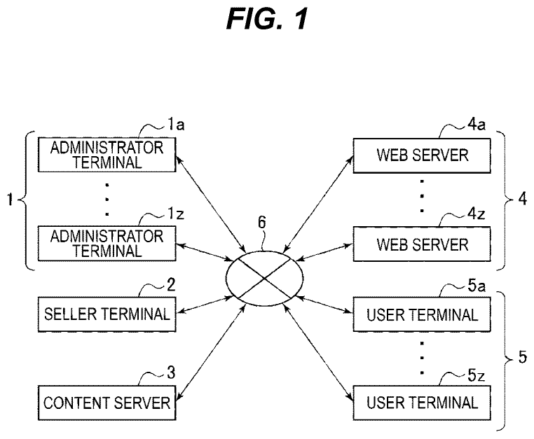

FIG. 1 is a block diagram illustrating a configuration of a sales system according to an embodiment of the present invention. As illustrated in the drawing, the sales system includes an administrator terminal 1, a seller terminal 2, a content server 3, a web server 4, a user terminal 5, and a communication network 6. The administrator terminal 1, the seller terminal 2, the content server 3, the web server 4, and the user terminal 5 can be communicably connected to each other via the communication network 6. In addition, the sales system may include a plurality of administrator terminals 1a to 1z, a plurality of seller terminals 2 (not illustrated), a plurality of web servers 4a to 4z, and a plurality of user terminals 5a to 5z.

The administrator terminal 1 is a terminal operated by an administrator (for example, a person in charge in a record company, a content holder, and the like) who administrates content. Specifically, the administrator refers to an administrator who performs setting registration of product information.

The seller terminal 2 is a terminal operated by a seller who sells products, and is operated by, for example, an operator who operates a platform such as an EC site (also referred to as website) that sells products, or a retailer who intends to sell products using the platform. The operator may manage the web server 4. Information in the web site is mainly transmitted to the user terminal 5 via the web server 4. The web server 4 stores information on products to be sold on the website. Note that the administrator terminal 1 and the seller terminal 2 may be operated by the same person or different persons. That is, the seller terminal 2 can be regarded as the administrator terminal 1.

The content server 3 mainly stores content information, benefit information, product information, and user information regarding users. The content server 3 may be managed by the administrator who operates the administrator terminal 1, or may be managed by the operator of the sales system.

The user terminal 5 is operated by a user who intends to purchase a product or a user who uses a purchased product. Hereinafter, a terminal operated by the user is referred to as the user terminal, and a terminal operated by another user is referred to as another user terminal.

The administrator terminal 1, the seller terminal 2, and the user terminal 5 may be any computer apparatus that includes a display screen and an input unit. The administrator terminal 1, the seller terminal 2, and the user terminal 5 may be stationary to be installed in an office of a company or the like, or may be portable to be able to be carried by a user while the user is moving. Examples of the administrator terminal 1, the seller terminal 2, and the user terminal 5 include a conventional mobile phone, a tablet terminal, a smartphone, a desktop/notebook personal computer, and the like. In the sales system according to one aspect of the present invention, it is preferable to use a mobile terminal in which a dedicated application program (hereinafter referred to as dedicated application) is installed as the user terminal 5.

In the embodiment of the present invention, a “first system” mainly refers to a system including the web server 4, and a “second system” mainly refers to a system including the content server 3. In addition, a system including the first system and the second system may be referred to as “sales system” in the present embodiment.

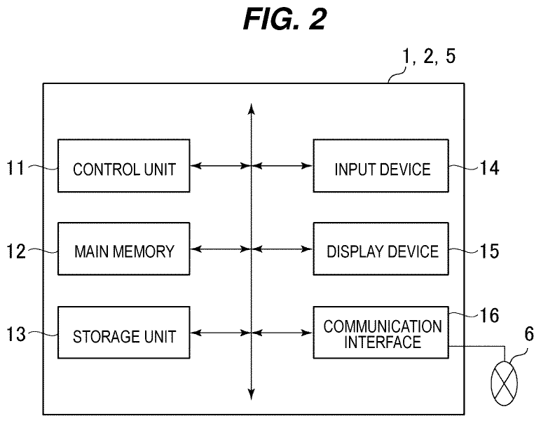

FIG. 2 is a block diagram illustrating a configuration of the administrator terminal according to an embodiment of the present invention. The administrator terminal 1 is provided with a control unit 11, a main memory 12, a storage 13, an input device 14, a display device 15, and a communication interface 16, which are mutually connected by buses. The administrator terminal 1 may also be provided with a sound output device.

The control unit 11 includes a CPU and a ROM. The control unit 11 executes programs stored in the storage 13 and controls the administrator terminal 1. As the main memory 12, for example, a RAM is used. The main memory 12 is a work area of the control unit 11. The storage 13 is a storage area for saving programs and data. The control unit 11 carries out arithmetic processing based on the programs and data read from the main memory 12 and the data input by the input device 14.

The display device 15 has a display screen. In accordance with the results of the arithmetic processing, the control unit 11 outputs video signals for displaying images on the display screen. Herein, the display screen may be a touch panel provided with a touch sensor. In such a case, the touch panel functions as the input device 14.

The communication interface 16 can be connected to the communication network 4 by radio or by wire and can transmit/receive data to/from the server apparatus 2 or the administrator terminal 3 via the communication network 4. The data received via the communication interface 16 is loaded into the main memory 12 and is subjected to arithmetic processing by the control unit 11.

The seller terminal 2 and the user terminal 5 have a configuration similar to the administrator terminal 1 and, for example, is provided with a control unit, a main memory, a storage, an input device, a display device, and a communication interface, which are mutually connected by internal buses. In addition, the user terminal 5 may be provided with a camera so that the camera functions as the input device 14.

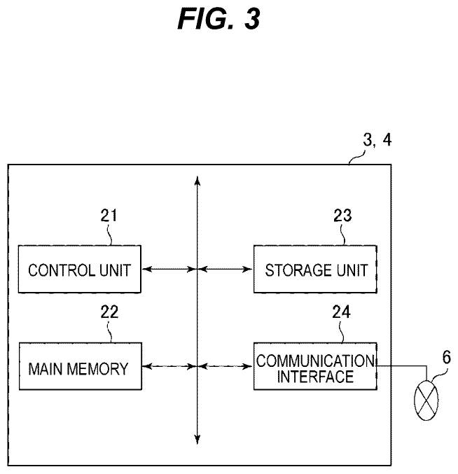

FIG. 3 is a block diagram illustrating a configuration of the content server according to an embodiment of the present invention. The content server 3 is provided with a control unit 21, a main memory 22, a storage 23, and a communication interface 24, which are mutually connected by buses.

The control unit 21 includes a CPU and a ROM, executes programs stored in the storage 23, and controls the content server 3. Also, the control unit 21 is provided with an internal timer, which measures time. The main memory 22 is a work area of the control unit 21. The storage 23 is a storage area for saving programs and data. The control unit 21 reads programs and data from the main memory 22 and carries out arithmetic processing based on, for example, the information received from the administrator terminal 1, the seller terminal 2, the web server 4, or the user terminal 5.

The web server 4 has a configuration similar to the content server 3 and, for example, is provided with a control unit, a main memory, a storage, and a communication interface, which are mutually connected by internal buses.

In the following embodiment of the invention, a mode will be described in which the content server 3 sets content information, benefit information, and product information, stores various types of information, transmits content information and benefit information, and the like. However, this mode may be achieved by a distributed ledger technology using a blockchain instead of the content server 3. In addition, a mode will be described in which the web server 4 sells products, provides content information and benefit information, and the like. However, this mode may be achieved by a distributed ledger technology using a blockchain instead of the web server 4. A blockchain network may be constructed as a private network or a public network. With the information management by the blockchain, security can be maintained and ownership of a product can be secured to the user.

The sales system according to the embodiment of the present invention provides the user with a product having content information and benefit information. With the sales system, the administrator can set the product having content information and benefit information and sell the product through one or more sales channels.

In addition, the sales system can set conditions related to lottery application related to various benefits included in the benefit information according to predetermined conditions (for example, information regarding purchase of the product). Examples of the information regarding purchase of the product include the number of purchases of the product, a purchase amount, a cumulative purchase amount, and a combination of purchased products. The sales system can also make the number of admission tickets owned by the user constant for an admission ticket included in the benefit information regardless of the predetermined conditions. In addition, the sales system can transmit a part or all of the content information to another user according to the predetermined conditions. Moreover, the sales system can detect the type of the user, the purchase date and time, the number of plays of content, the number of times of transmitting content to another user, and the like with respect to the product purchased by the user, so that statistical information regarding sales can be suitably managed.

Here, in the embodiment of the present invention, the “content” can be applied not only to music but also to general digital content such as images, moving images, movies, drama, electronic books, and games. That is, the “content” includes all of music information, audio information, image information, moving image information, and character information. The “content information” refers to information regarding content. For example, in the case of music content, the content information may include a plurality of pieces of information such as a lyric card and a jacket photo in addition to information of a sound source of a music piece. That is, the content information may be information included in various contents typically included in a CD.

In the embodiment of the present invention, the “benefit information” is information provided to the user accompanying the content information when the product is purchased. The benefit information is information regarding a benefit related to the content information, and is also referred to as information regarding a campaign related to the content information. Examples of the information regarding a benefit (campaign) related to the content information include information regarding an event related to the content information, information regarding merchandise related to the content information, information regarding a digital benefit, and the like. The benefit related to the content information is not particularly limited as long as it enhances additional value of the product, for example, content, a gift, a right to apply to various lotteries, a right to participate in an event related to the content information, or an option or other products that can be executed by the user in the event related to the content information.

In addition, a GIFT sending function may be provided as the benefit related to the content information. The “GIFT sending function” refers to a function capable of transmitting a part or all of the content information and/or the benefit information to another user according to the predetermined conditions, in particular, the number of purchases of the product purchased by the user, by the user operating the user terminal. The GIFT is the content information and/or the benefit information that can be transmitted to another user. The administrator can appropriately set the GIFT sending function, and can set, for example, the number of plays of the GIFT, whether the gift is downloadable, the play period of the gift, and the like.

The information regarding an event includes information regarding an admission ticket to the event and information regarding a benefit ticket used in the event. The information regarding merchandise related to the content information includes information regarding real merchandise such as a tote bag or a towel related to the content. The information regarding a digital benefit includes another content related to the content, and is music information, audio information, image information, moving image information, and/or character information.

The “admission ticket” has information regarding admission to or participation in an event related to the content information. The admission ticket may be, for example, one that promises a right for admission to the event, or one that allows application to a lottery related to the admission to the event. The admission ticket may also indicate an admission reference number or a seat number in the event. In addition, the event includes both an event held at an actual event venue and an event held online. The admission ticket is also referred to as ticket. In addition, the type and rank of a seat in the event may be made different according to the number of acquired admission tickets. That is, the type and rank of the seat in the event are different according to predetermined information regarding the admission to the event.

The “benefit ticket” includes information regarding a benefit in the event related to the content information. The user can select different options in the event related to the content information according to the number of acquired benefit tickets. The different options may be ranked individually. That is, the types and ranks of the options that can be executed in the event are different according to predetermined information regarding the benefit ticket. Examples of the selectable options include acquisition of a gift, handshaking with an artist, taking a photo with an artist, conversation for a predetermined time, and the like.

In addition, a serial code (also referred to as serial number) may be provided to the user as the benefit ticket and/or the admission ticket. The serial code is represented by random alphanumeric characters or symbols, and a code with different alphanumeric characters or symbols is issued for each product. Different for each product means that the serial code is different for each purchased product when a plurality of products of the same type are purchased. With the serial code, it is possible to acquire the right to participate in the event related to the content information, acquire the benefit related to the content information, or apply to the lotteries of the right and the benefit. The serial code may be stored in association with product information to be described later. In addition, the serial code may be provided to the user as the benefit without being associated with the benefit ticket and the admission ticket. The serial code may make it possible to acquire limited content or a limited gift or to apply to a lottery of them. The use of the serial code is not particularly limited. Note that the application related to the event or various benefits from the serial code can be executed from an external site such as a dedicated site of an artist related to the content information or a dedicated application downloaded to the user terminal 5. In addition to the serial code, the URL of a site that allows the application related to the event or various benefits, and the URL of a site where music information, audio information, image information, moving image information, and character information related to the content can be downloaded may be provided to the user.

The “digital benefit” is content related to the content information, and is information different from the content information. The digital benefit is not particularly limited as long as it is digital content. Examples thereof include an artist image, a secret moving image related to the content information, an alarm sound, and the like. In addition, the digital benefit may be provided with limits on the number of plays and the play period. Moreover, the digital benefit may be played only in the dedicated application, may be stored in the storage of the user terminal 5, or may be played by another application program of the user terminal 5. Specific detail of the content information and the benefit information can be appropriately set by operating the administrator terminal 1 by, for example, an artist, an administrator, or an event promoter.

In the embodiment of the present invention, the “product information” is information regarding the product that can be purchased by the user, and is information capable of specifying a combination of the content information and the benefit information. For example, information in which the content information and the benefit information are stored in association with each other may be used as the product information. In addition, the product information may include at least the content information without including the benefit information, or may include either the content information or the benefit information. The product information may also be information in which content identification information capable of identifying the content information and benefit identification information capable of identifying the benefit information are stored in association with each other.

The product information may be stored in association with a serial code. The user may acquire the content information and/or the benefit information specified by the product information by using the serial code. The serial code can function as product identification information to be described later. Since products of the same type each have different serial codes, at least one or more serial codes can be stored in association with one piece of product identification information. Note that the serial code functioning as the product identification information may be information different from the serial code provided as the benefit. In addition, the “product” refers to, for example, a target of commercial transaction, and may be a tangible object or an intangible object. That is, the administrator can set, in the system, a product that can be purchased online and a product that can be purchased in an actual store.

### Product Setting Processing

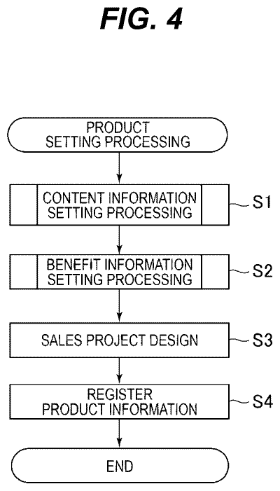

First, product setting processing that is a process of generating the product information in the first system will be described. FIG. 4 is a diagram illustrating a flowchart of the product setting processing according to the embodiment of the present invention. The administrator logs in to the first system by accessing the content server 3 from the administrator terminal 1 via a web browser. The login to the first system may also be performed by activating an application program downloaded to the administrator terminal 1 and accessing the content server 3.

In addition, it is preferable to cause the administrator to operate the administrator terminal 1 to set initial settings of a person in charge. As the initial settings of the person in charge, company information, a department to which the person in charge belongs, browsing authority, the name of the person in charge, a telephone number, an e-mail address, an artist managed by the person in charge, and the like are input. The browsing authority can set a configuration in which the person in charge can browse, register, or edit only information regarding the artist managed by the person in charge, and/or a configuration in which the person in charge can browse information regarding all artists in the first system. The person in charge whose settings have been registered may be given administrator identification information (also referred to as administrator ID) for each person in charge.

The administrator can register information regarding an artist by operating the administrator terminal 1, and preferably registers the information regarding an artist in the content server 3 in advance. As the information regarding an artist, an artist name, an official site, content, and the like can be registered.

First, the administrator operates the administrator terminal 1 to perform content information setting processing (step S1). In the content information setting processing in step S1, at least one piece of content information of a product to be sold is registered. Next, the administrator operates the administrator terminal 1 to perform benefit information setting processing (step S2). In the benefit information setting processing in step S2, at least one piece of benefit information is set in association with the content information registered in step S1.

Next, the administrator operates the administrator terminal 1 to perform sales project design (step S3). The sales project design is a process of setting the product to be sold to the user. In the sales project design, the administrator selects one content from contents corresponding to the one or plurality of pieces of content information set in step S1. In addition, the administrator selects one or a plurality of benefits from benefits corresponding to the one or plurality of pieces of benefit information set in step S2. Since the benefit information is set in association with the content information in step S2, the content and the benefit can be selected by selecting the one or plurality of pieces of benefit information.

Here, the product can be designed by combining the one selected content and the one or plurality of selected benefits. When the administrator operates the administrator terminal 1 to select the one content and the one or plurality of benefits, product information capable of specifying a combination of the content information corresponding to the one selected content and the benefit information corresponding to the one or plurality of selected benefits is generated. The product information may include product identification information. The product identification information included in the product information may be stored in the content server 3 in association with the content information and the benefit information to be targeted for combination. In addition, the product identification information included in the product information may be stored in the content server 3 in association with content identification information corresponding to the content information and benefit information corresponding to the benefit information to be targeted for combination. In this manner, the product information and the product identification information are registered (step S4). The product information setting processing ends by the processing in steps S1 to S4.

As described above, in the product information setting processing, it is possible to generate one piece of product information by associating the at least one piece of content information stored in step S1, the at least one piece of benefit information stored in step S2, and the product identification information capable of identifying the combination of the one piece of content information and the one piece of benefit information according to the operation on the administrator terminal 1 by the administrator.

### Content Information Setting Processing

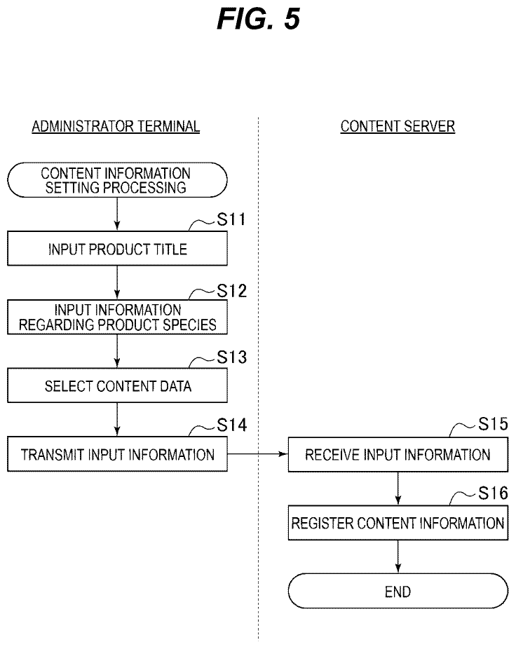

Next, the content information setting processing in step S1 will be described in detail. FIG. 5 is a diagram illustrating a flowchart of the content information setting processing according to the embodiment of the present invention.

The administrator operates the administrator terminal 1 to input a product title (step S11). The product title indicates the title information of a product species related to the product to be sold, and is also referred to as master title. The title information includes an artist name, a title name, a music genre, and/or a label name, for example.

Here, the product species refers to the content information of the product to be sold to the user, has the same or different content information for each product, and is associated with the same or different benefit information for each product. The product species is also referred to as product variation, and is stored in association with the product title. For example, when the product title is “title A”, the product species having names such as “title A normal edition”, “title A initial limited edition”, and “title A initial limited edition type A” can be set. The “title A normal edition”, “title A initial limited edition”, and “title A initial limited edition type A” can each have different content information and be associated with different benefit information. In addition, even the product species having the same name may have different content information and be associated with different benefit information.

Next, the administrator operates the administrator terminal 1 to input information regarding the product species (step S13). As the input items, for example, the basic information of the product species, the name of the product species, the sales start date and time of the product, the download start date and time of the content information, a product number, a sales price, and the like are set. In the basic information of the product species, the operator of the sales system may operate the terminal in advance to set one or more types of basic information in the content server 3. As the basic information, for example, information such as the data capacity of the content information corresponding to the product information, the number of music registrations included in the content information, and the minimum sales amount is set. In addition, the administrator can select whether the product species to be set is a product sold online or a product sold in an actual store by operating the administrator terminal 1.

The sales start date and time of the product and the download start date and time of the content information may be the same date and time, or different dates and times. As a result, the product can be sold before the download start date and time of the content information.

Since the product information corresponds to the content information and the benefit information, it is possible to set a price including a price as compared with a case where the content information is sold alone. While the content information can be purchased alone, it is preferable that a benefit ticket, an admission ticket, a digital benefit, merchandise, and/or a serial code included in the benefit information cannot be purchased alone. Note that the administrator can set one or more product species related to the product title. The administrator can also set a new product species by copying the information of the product species already input.

Next, the administrator operates the administrator terminal 1 to select content data to be associated with the product species (step S13). The content data to be selected may be music data, moving image data, or the like stored in advance in the content server 3, or may be music data or moving image data stored in the storage unit 13 of the administrator terminal 1 or another server apparatus. In addition, the administrator can appropriately edit the content data by operating the administrator terminal 1. In the content information setting processing, content registered in step S16 is referred to as content information, and content before registration is referred to as content data.

The administrator terminal 1 transmits the input information input and selected in steps S11 to S13 to the content server 3 (step S14). The content server 3 receives the input information (step S15). The content server 3 stores the information regarding the product species and the content data in association with each other on the basis of the received input information, thereby registering the information as the content information (step S16). Note that content identification information (also referred to as content ID) capable of identifying the content information is assigned to the registered content information. In step S16, the content ID is registered in association with the content information. One product species and another product species can be distinguished by the content ID. In addition, the content ID may be registered in a product database of the content server 3 in association with the above-described administrator ID. The content information setting processing ends by the processing in steps S11 to S16.

Note that step S13 can be omitted in the content information setting processing. In this case, the content information to be registered is in a temporarily saved state. Specifically, the selection of the content data only needs to be registered by the download start date and time of the content information even after product release. When the content information is in the temporarily saved state a predetermined period (for example, one week) before the download start date and time of the content information, the first system may notify the terminal of the person in charge of the content information of the fact.

### Benefit Information Setting Processing

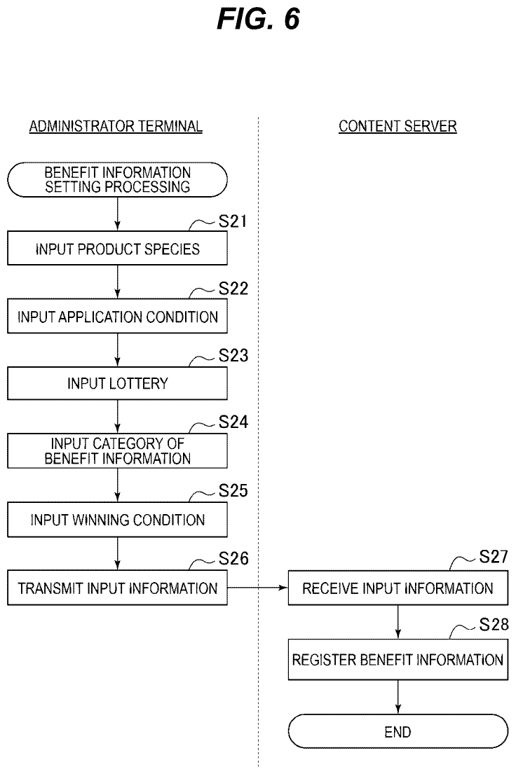

Next, the benefit information setting processing in step S2 will be described in detail. In the benefit information setting processing, the benefit included in the product can be set by inputting options regarding the benefit and information regarding the benefit. In addition, the benefit information setting processing can associate at least one content with at least one benefit. FIG. 6 is a diagram illustrating a flowchart of the benefit information setting processing according to the embodiment of the present invention.

The administrator operates the administrator terminal 1 to input a product species (step S21). Specifically, first, the administrator selects a target product species for which the benefit information is to be set. The administrator may select a plurality of product species. In addition, the administrator inputs the basic information of the benefit information. Examples of the basic information of the benefit information include the name of the benefit information (also referred to as campaign name), the release period of the benefit information, the outline of the benefit information, and the like.

Next, the administrator operates the administrator terminal 1 to input a benefit application condition (step S22). The administrator defines the number of times or the number of rights with which a predetermined benefit can be obtained when the user purchases the product, as the benefit application condition. Alternatively, the administrator defines the number of applications or the number of rights for application to a lottery for obtaining a predetermined benefit. The input items of the application condition include “1 product 1 application right” in which one right can be acquired when one product is purchased from among products related to the target product species, “amount of money application” in which the right can be acquired according to a product purchase amount, and “combination application” in which the right can be acquired according to purchase of a combination of products designated by the administrator. The administrator operates the administrator terminal 1 to select one of the application conditions. In addition, the administrator can appropriately input settings of these conditions including the number of rights granted to the user by operating the administrator terminal 1.

Note that a plurality of application conditions associated with one or more benefits can be set in one piece of benefit information, and each application condition is referred to as application course. The application course may include a plurality of benefits. In a case where the application course includes a plurality of benefits, it is preferable to make it possible to acquire any one of the benefits or apply to any one of the benefits according to the number of rights granted for each application course.

Here, the administrator can set the purchase amount of the product of “amount of money application” by operating the administrator terminal 1. The purchase amount of the product can target the cumulative amount of money for the product related to the target product species selected above. In addition, one right may be granted when the amount of money exceeds a certain amount, one right may be granted for each predetermined amount of money, or the number of rights to be granted may be varied according to a predetermined amount of money. Note that the purchase amount of the product can be a cumulative purchase amount for products related to all product species related to the product title or a cumulative purchase amount for products related to one product species.

In addition, the administrator can set a condition of combination of products related to the “combination application” by operating the administrator terminal 1. In the “combination application”, assume that the products related to the product species include a product A1, a product A2, a product B1, a product B2, and a product C. In a case where one of the product A1 or the product A2, and one of the product B1, the product B2, or the product C are purchased, the right to apply to a lottery once may be granted. The combination of products for performing the combination application, the number of products purchased, the number of combinations for achieving the condition, and the number of rights granted are not particularly limited. The combination of products may be made by selecting products related to one product species. For example, the right to apply to a lottery can be granted according to purchase of a product related to one product species a predetermined number of times (for example, twice).

Next, the administrator operates the administrator terminal 1 to input a lottery related to the benefit (step S23). As the lottery related to the benefit, one of a standard lottery, a real-time lottery, or distribution to everyone is selected. The “standard lottery” is a lottery in which an application period and a lottery date and time are set by operating the administrator terminal 1, and lottery processing is performed on all users who have applied to the lottery on the set date and time to determine a prizewinner. In the “real-time lottery”, the administrator terminal 1 is operated to set an application period, the expected number of applications on the first day, and the expected number of applications on the final day. The content server 3 performs lottery processing in response to receiving a request for lottery application from the user. This enables the user to know the result of the lottery in real time. The “distribution to everyone” provides a benefit to users who have applied to the lottery without performing lottery processing. That is, in the lottery input in step S23, it is possible to set not to perform the lottery processing by operating the administrator terminal 1. In the case of setting not to perform the lottery processing, the benefit can be automatically granted to the user terminal 5 according to the number of application rights acquired by the user. In addition, as the setting not to perform the lottery processing, a first-come-first-served basis can be adopted for the purchase or application of the product. In this case, the administrator operates the administrator terminal 1 to set the upper limit of the number of wins.

Next, the administrator operates the administrator terminal 1 to input the category of the benefit information (step S24). Specifically, for the benefit type (also referred to as benefit or prize) that allows application to the lottery, settings such as a prize name, selection of the category of the benefit information, the upper limit of the number of wins, and the like are optionally input. This setting processing is also referred to as gift registration. There is no particular limitation on what the administrator can set by operating the administrator terminal 1 as long as it is benefit information. For example, the administrator can set the upper limit of the number of distributions of various benefits, a distribution period or other distribution limits, a usage limit, and the like. Note that the upper limit of the number of wins refers to the upper limit of the number of distributions to distribute the benefit. Alternatively, the upper limit of the number of wins may be the number of users to distribute the benefit.

Specifically, the category of the benefit information can be selected from an admission ticket, a benefit ticket, merchandise, a digital benefit, a serial code, or the like. The upper limit of the number of wins may be set to no upper limit. The number of set prizes is not particularly limited. The user can acquire the right to apply to a predetermined number of lotteries according to the application condition set in step S22, and can apply to any of the prizes set in step S24 according to the number of acquisitions. In addition, the lottery settings can be further registered for the benefit of each prize. Moreover, the maximum number of applications to the lottery may be set for each user terminal 5 of one user, or a purchasing limit in one payment may be set for a purchased product.

Next, the administrator operates the administrator terminal 1 to input a winning condition (step S25). For each prize set in step S24, the administrator inputs settings such as blacklist settings, whether or not the same user can win multiple times, and restriction on duplicated winning with another prize.

In the blacklist settings, the administrator operates the administrator terminal 1 to select a specific user from users registered in the content server 3. In this manner, even when the selected specific user operates the user terminal 5 to apply to a lottery for a prize for which the blacklist is set, the user never wins the lottery for the prize. Alternatively, the winning probability of the lottery for the prize is reduced. Such settings are referred to as blacklist settings. As a result, a user who has performed a nuisance or a user who has performed illicit acquisition or illicit transfer of a benefit in the past events cannot win the lottery for a specific prize such as an admission ticket to an event, or the winning probability is reduced, which makes it possible to ensure the safety of an artist and event participants and fair management. In a case where it is set not to perform the lottery processing, it is preferable not to perform the blacklist settings.

As a lottery method in which the blacklist settings are performed, the following method can be adopted. The “standard lottery” is a method in which a unique number is assigned to each user who has applied, and the unique number is determined by drawing. Note that user identification information may be used as the unique number. When the blacklist settings are performed, the number unique to a predetermined user selected by the operation input to the administrator terminal 1 is excluded from a lottery base. That is, the user selected by the input operation to the administrator terminal 1 does not enter the lottery base even if the user applies to the lottery. The “real-time lottery” is a method of performing a lottery for each prize or for each user according to a predetermined probability. When the blacklist settings are performed, the lottery is performed by reducing the winning probability or changing the winning probability to zero for a predetermined user selected by the operation input to the administrator terminal 1. That is, for the user selected by the operation input to the administrator terminal 1, the winning probability can be reduced by a predetermined percentage.

In addition, in the embodiment of the present invention, settings in which the winning probability is increased by a predetermined percentage may be adopted for a predetermined user. The user for which the winning probability is increased may be a user selected by the administrator, or may be a user who has purchased a predetermined product by a predetermined amount of money or more, a user who applies to a lottery for the first time, or a user who has purchased a predetermined product a predetermined number of times or more or a predetermined number of times or less.

The administrator terminal 1 transmits the input information input in steps S21 to S25 to the content server 3 (step S26). The content server 3 receives the input information (step S27). The content server 3 stores the input information to register the benefit information (step S28). In step S28, benefit identification information (also referred to as benefit ID) capable of identifying the benefit information may be issued. In step S28, the benefit ID is registered in association with the benefit information. The benefit ID may be registered in the product database in association with the content ID of the target product species selected in step S21 and the administrator ID. The benefit information setting processing ends by the processing in steps S21 to S28.

Note that the order of steps S22, S23, and S24 may be changed. That is, instead of the configuration in which the application condition and the lottery are input for all the prizes set in step S24, the application condition and the lottery may be input for each prize set in step S24.

Here, a lottery method for an admission ticket will be described. In the embodiment of the present invention, only one admission ticket related to one event is provided to one user. Therefore, in a case where the user has no admission ticket and wins an admission ticket as a result of lottery, the admission ticket is provided to the user. At this time, the information of the admission ticket is stored in the content server 3 in association with the user ID. In a case where the user already has an admission ticket and wins another admission ticket as a result of lottery, the content server 3 compares the already-acquired admission ticket with the admission ticket that the user has won, stores the higher-rank admission ticket, and transmits the winning result to the user terminal 5. In addition, in a case where the user does not have any admission ticket and cannot acquire any admission ticket by drawing, the information of the admission ticket is not stored in the content server 3 in association with the user ID.

Specifically, assume that a seat number is associated with the admission ticket, and the smaller the number, the higher the rank. In this case, when the number of the admission ticket acquired last time is “300” and the number of the admission ticket that can be acquired this time is “10” as a result of lottery, the newly acquired admission ticket is stored in the content server 3, and the information of the admission ticket acquired last time is deleted. The admission ticket with the number “300” acquired last time is returned to the lottery denominator of the admission ticket. In the case of the standard lottery, for the admission ticket returned to the lottery denominator, the first lottery processing may be performed on the set lottery date and time, and then the lottery processing may be repeatedly performed until all the admission tickets are distributed to the users. The admission ticket may guarantee admission to the event for the admission ticket with a predetermined number or less. For example, only the admission ticket with an admission ticket number of “200” or less may be admitted to the event. In a case where there is a plurality of lottery applications for the admission ticket at a time, the lottery processing can be performed in the same manner as described above. Specifically, the content server 3 can compare the results of the lottery and store only the admission ticket with the highest rank in association with the user ID. In a case where the user wins a plurality of admission tickets, the results of lottery may be displayed on the display screen of the user terminal 5, and one admission ticket desired by the user may be selected. When the selection input operation is performed, only the selected admission ticket is stored in the content server 3.

In addition, in a case where there is a plurality of events related to the admission ticket to which the user can apply, it may be determined whether or not the user has the admission ticket for each event. When there is at least one event for which the user has the admission ticket, no admission ticket may be granted to the user.

Note that a configuration can also be adopted in which the user has a plurality of admission tickets for one event. At this time, it is preferable that the admission ticket functions as a lottery ticket for participating in the event without guaranteeing participation in the event. In addition, the rank of the seat may be changed to a higher rank, such as from B to A or from A to S, under a predetermined condition. The predetermined condition may be, for example, a condition related to the admission ticket, such as the number of admission tickets, or a condition related to purchase, such as the number of purchases of the product. In addition, the type of the seat may be changed under a predetermined condition. For example, a specific seat or a place such as the lower side or upper side of a venue can be designated according to the number of admission tickets or the number of purchases of the product. Moreover, an upper limit may be set for the number of acquired admission tickets.

### Sales Project Design

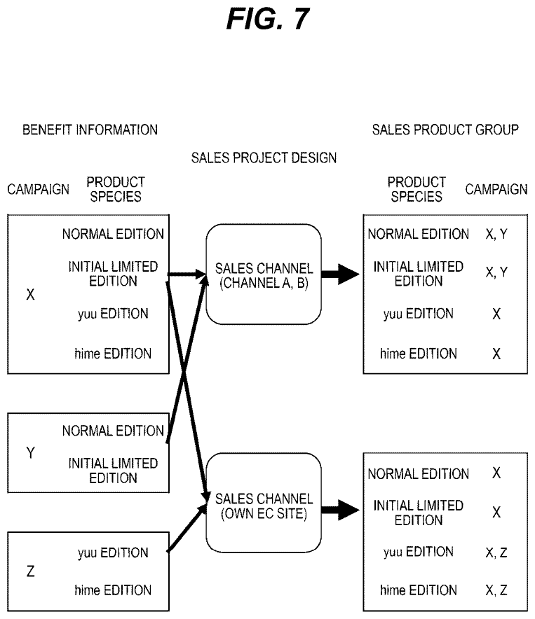

Next, the sales project design will be described in detail. FIG. 7 is a diagram illustrating the sales project design according to the embodiment of the present invention. In the benefit information set in step S2, the campaign and the target product species are stored in association with each other. The campaign refers to one having information regarding the benefit in which the benefit, the application condition, and the lottery method are set. Therefore, the administrator can design a sales product in which the content information and the benefit are combined by selecting one or more pieces of benefit information by the operation input to the administrator terminal 1. At this time, a channel through which products are sold (also referred to as sales channel) may be selected. The sales channel is a place where products are sold, and is a website, an actual store, or the like. The administrator can design the product to be sold through the selected sales channel by combining one or more pieces of benefit information by the operation input to the administrator terminal 1. The products related to the product species sold through a specific sales channel are also collectively referred to as product group.

Specifically, channels A and B are selected as the sales channel by the operation input to the administrator terminal 1. In addition, as the benefit information to be combined, a campaign X and a campaign Y are selected. In this manner, as the products related to the product species to be sold through the channels A and B, a normal edition having the campaigns X and Y, an initial limited edition having the campaigns X and Y, a yuu edition having the campaign X, and a hime edition having the campaign X are designed. On the other hand, an own EC site is selected as the sales channel by the operation input to the administrator terminal 1. In addition, as the benefit information to be combined, the campaign X and a campaign Z are selected. In this manner, as the products related to the product species to be sold on the own EC site, a normal edition having the campaign X, an initial limited edition having the campaign X, a yuu edition having the campaigns X and Z, and a hime edition having the campaigns X and Z are designed. The product identification information is assigned to each product related to the product species to be sold through the channels A and B and each product related to the product species to be sold on the own EC site. As a result, it is possible to set the sales products of the same product species but associated with different benefits, and to provide a variety of sales products. Note that the product identification information may be registered in the product database of the content server 3 in association with the content ID, the benefit ID, the administrator ID, and the information regarding the sales channel.

An example of the set sales product will be described. For example, in a case where each of the campaigns X, Y, and Z grants the application right under the application condition of “1 product 1 application right”, the user who has purchased the normal edition once through the channel A is granted one application right in each of the campaigns X and Y. On the other hand, the user who has purchased the normal edition once on the own EC site is granted one application right in the campaign X.

In addition, for example, in a case where each campaign has a different benefit release period (also referred to as distribution period), the benefit that the user can acquire can be made different depending on the purchase timing even when the user purchases the same product. The benefit distribution period is set such that the campaign X grants a benefit ticket in the first week from the release date of the sales product, and the campaign Y grants a digital benefit in the second week from the release date of the sales product. In this manner, the user who has purchased the normal edition through the channel A in the first week from the release date of the sales product can acquire the benefit ticket but cannot acquire the digital benefit. On the other hand, the user who has purchased the normal edition through the channel A in the second week from the release date of the sales product cannot acquire the benefit ticket but can acquire the digital benefit.

The sales project design allows the administrator to design products with different benefit information depending on the sales channel. In addition, in the sales project design, the seller may edit the price, the sales date and time, and the like of the sales product by the operation input to the administrator terminal 1.

As described above, the product identification information can specify the benefit information combined with the product species (content information) corresponding to the sales product. Therefore, by notifying a channel other than the selected sales channel of the product identification information, the sales product can be sold through the channel other than the selected sales channel.

Note that the content information and the benefit information specified by the product information registered in the product setting processing may be made editable until the release date of the product, for example. In addition, even after the release of the product, the benefit information may be set in consideration of the sales transition of the product. The product setting processing is performed by the administrator. However, the person in charge of the product may execute steps S1 to S3, and the final administrator may approve the execution, so that the process of registering the product identification information of the sales product in step S4 may be completed. For approval, a typical electronic signature or timestamp can be used. It is preferable that the product information, and the content information and the benefit information corresponding to the product information cannot be edited any more after approval. In addition, for the product for which the release date is set, the processing in step S4 may be executed without approval, so that the product may be released.

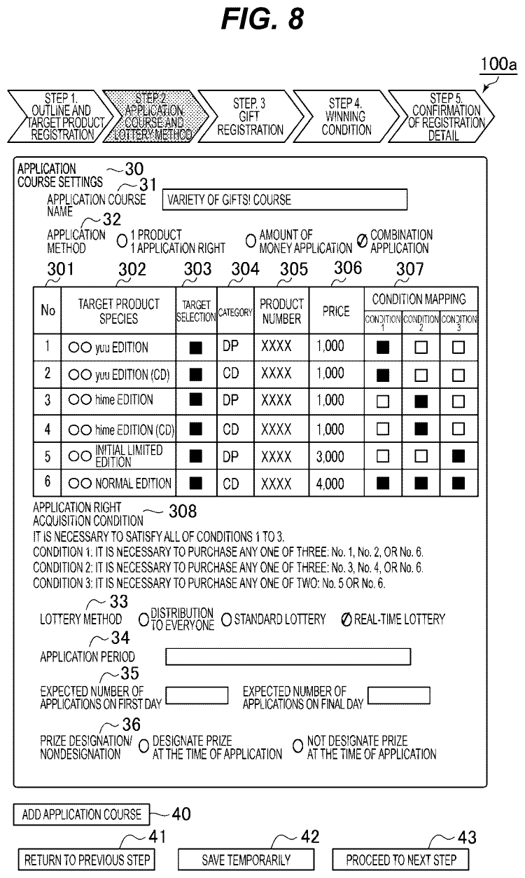

Next, the display screen of the administrator terminal 1 in the first system of the present invention will be described. FIG. 8 is a diagram illustrating an example of the display screen of the administrator terminal according to the embodiment of the present invention. FIG. 8 illustrates the display screen when executing the input for setting the application condition in step S22 and setting the lottery in step S23. When the target product species is selected by the operation input to the administrator terminal 1 in the benefit information setting processing, a benefit information setting screen 100a in FIG. 8 is displayed.

On the benefit information setting screen 100a, an application course name 31, an application method 32, a lottery method 33, prize designation/non-designation 36, and the like are displayed as application course settings 30. The name of the application condition of the benefit information to be set is input to the application course name 31. The application method 32 selects one from the 1 product 1 application right, the amount of money application, or the combination application. Hereinafter, a case where the combination application is selected will be described.

When the combination application is selected, No. 301 of the product, a target product species 302, target selection 303, a category 304, a product number 305, a price 306, condition mapping 307, an acquisition condition 308, and the like are displayed. As the target product species 302, the target product species selected by the administrator are displayed. In the target selection 303, the product species as the target of the application condition to be set is selected. The category 304 indicates the category of the product species. Here, a product sold online is denoted as DP, and a product sold as a CD medium in an actual store is denoted as CD. The product number 305 is a unique number issued for each product species, and is appropriately determined by the administrator. The price 306 indicates the price of the product species.

In the condition mapping 307, a combination related to the combination application can be set. The acquisition condition of the application right by combination is displayed in the acquisition condition 308. In FIG. 8, a condition 1, a condition 2, and a condition 3 are set, and one lottery application right is granted when all the conditions 1 to 3 are satisfied. In the condition mapping 307, No. 1, No. 2, and No. 6 are selected as the condition 1, No. 3, No. 4, and No. 6 are selected as the condition 2, and No. 5 and No. 6 are selected as the condition 3. Therefore, one application right can be acquired by purchasing any one of the products No. 1, No. 2, or No. 6, any one of the products No. 3, No. 4, or No. 6, and any one of the products No. 5 or No. 6. Specifically, the user who has purchased the products No. 1, No. 3, and No. 5 can acquire one application right. In addition, the user who has purchased the product No. 6 three times can acquire one application right. Moreover, the administrator may set the number of purchased products in addition to the combination of products, for example, for the acquisition condition of the application condition by the operation input to the administrator terminal 1.

The product species selected in the target selection 303 is selected under any condition in the condition mapping 307. In a case where the product species is not selected under any condition in the condition mapping 307, it can be considered that the product species is deselected in the target selection 303. Note that the number of conditions related to the combination is not particularly limited, and can be optionally increased or decreased by the operation input to the administrator terminal 1.

In a case where the amount of money application is selected in the application method 32, a column for inputting an application unit amount is displayed. The administrator inputs the application unit amount. In a case where the 1 product 1 application right is selected in the application method 32, nothing special is displayed.

The lottery method 32 selects one from the distribution to everyone, the standard lottery, or the real-time lottery. Hereinafter, a case where the real-time lottery is selected will be described.

When the real-time lottery is selected, an application period 34 and the expected number of applications 35 are displayed. The administrator inputs a period during which the user can apply to the benefit, the expected number of applications on the first day, and the expected number of applications on the final day. The first system calculates the winning probability during the application period on the basis of the application period, the expected number of applications on the first day, the expected number of applications on the final day, and the number of wins.

In a case where the standard lottery is selected in the lottery method 32, a column for inputting the lottery date and time and the application period are displayed. In a case where the distribution to everyone is selected in the lottery method 32, nothing special is displayed.

The prize designation/non-designation 36 is displayed in a case where a plurality of products is set for the application course. In the prize designation/non-designation 36, whether or not to designate a prize is selected when the user applies to the lottery.

On the benefit information setting screen 100a, an icon 40 for adding an application course, an icon 41 for returning to the previous step, an icon 42 for temporarily saving, an icon 43 for proceeding to the next step, and the like are displayed. By pressing these icons, the processing displayed on the icons is executed. In a case where the icon 40 is pressed, new application course settings 30 are displayed, and the administrator can perform similar input processing regarding the application method and the lottery method.

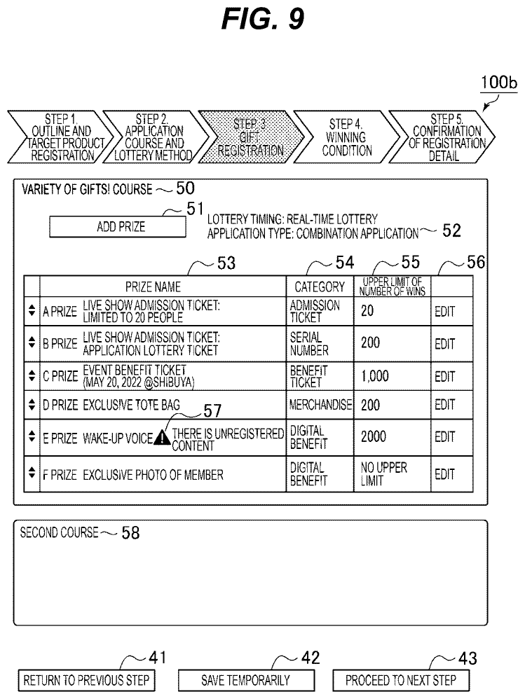

FIG. 9 is a diagram illustrating an example of the display screen of the administrator terminal according to the embodiment of the present invention. FIG. 9 illustrates the display screen when executing the input for setting the category of the benefit information in step S24. By pressing the icon 43 in FIG. 8, a benefit information setting screen 100b in FIG. 9 is displayed.

On the benefit information setting screen 100b, an application course name 50 of the application course for which the application condition and the lottery method are set is displayed, and an icon 51, a description 52, a prize name 53 that the user can apply to, a category 54, an upper limit 55 of the number of wins, edit 56, and the like are displayed. The administrator can add a prize that the user can apply to by pressing the icon 51. In the description 52, the lottery timing and the application type of the application course name 50 are displayed.

In the prize settings, the prize name 53, the category 54, and the upper limit 55 of the number of wins are set. In a case where the admission ticket is selected as the category, information regarding the event is registered. Specifically, the information regarding the event is a venue name, a date and time, an opening time, a show time, a caution, and the like. In addition, with respect to the reference number of the admission ticket, it is possible to select whether the reference number is issued. In a case where the reference number is issued, it is possible to select whether the admission ticket is issued on a first-come-first-served basis or on a random basis. Furthermore, the user terminal 5 of the winner user can be set to be notified of a reminder of the event on a predetermined date and time.

In a case where the benefit ticket is selected as the category, information regarding the benefit is registered. Specifically, the information regarding the benefit is information on the event in which the benefit ticket can be used, the number of benefit tickets distributed by one win, the benefit that the user can obtain according to the number of benefit tickets, a caution, and the like. Examples of the benefit that the user can obtain according to the number of benefit tickets include handshaking with an artist using two cards, taking an Instax photo with an artist using three cards, and a signed cardboard using five cards. Furthermore, the user terminal 5 of the winner user can be set to be notified of a reminder of the event on a predetermined date and time.

In a case where the digital benefit is selected as the category, a content of the digital benefit is registered. The distribution date and time of the digital benefit may be set. In addition, a period during which the content of the digital benefit can be used may be set. Moreover, a limit on the number of downloading times of the digital benefit may be provided. Furthermore, a usage limit may be provided for the content of the digital benefit. Specifically, the content of the digital benefit may be used only in the dedicated application or may be stored in the storage unit of the user terminal 5. In addition, the administrator or the like can optionally set a time when the digital benefit can be downloaded. Furthermore, for the downloaded digital benefit, a period in which the digital benefit can be played may be set, or the number of plays may be limited.

In a case where the serial code is selected as the category, information regarding the serial code is registered. Specifically, the information regarding the serial code is the number of issued serial codes, a URL used for application to a predetermined benefit from the serial code, an expiration date, a caution, and the like. In a case where the merchandise is selected as the category, information regarding the merchandise is registered. Specifically, the information regarding the merchandise is the name of the merchandise, the description of the merchandise, the image of the merchandise, and the like.

In a case where there is unregistered information regarding the prize, an icon 57 may be displayed near the prize name 53 to prompt the administrator to register the information. The registered detail of the prize can be edited with the screen switched to an edit screen by pressing the edit 56.

In FIG. 8, in a case where a plurality of application courses is set, the column of an application course name 58 is displayed for each application course, and similar input processing as the settings of the prize in the column of the application course name 50 described above can be performed. In addition, in the benefit information setting screen 100, the icons 41 to 43 are displayed as in FIG. 8.

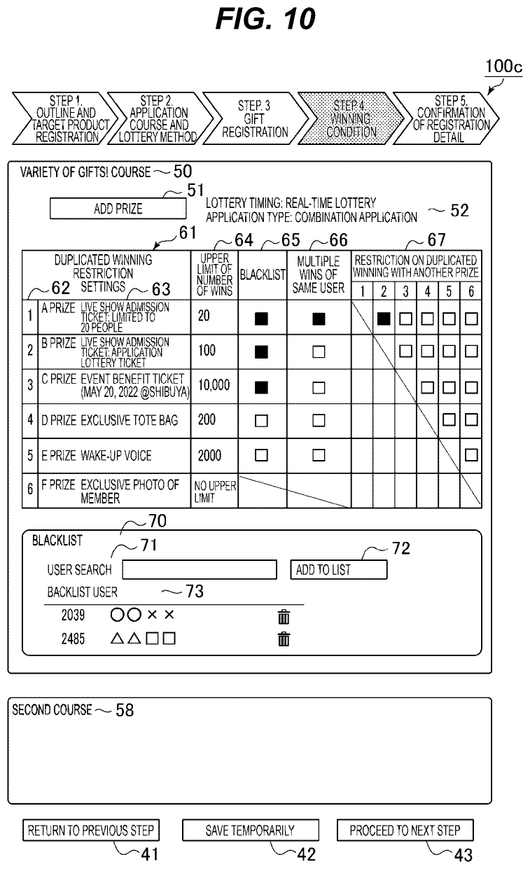

FIG. 10 is a diagram illustrating an example of the display screen of the administrator terminal according to the embodiment of the present invention. FIG. 10 illustrates the display screen when the executing the input for setting the winning condition in step S25. By pressing the icon 43 in FIG. 9, a benefit information setting screen 100c in FIG. 10 is displayed.

On the benefit information setting screen 100c, the application course name 50 of the application course for which the application condition and the lottery method are set is displayed, and the icon 51, the description 52, and duplicated winning restriction settings 61 are displayed. In the duplicated winning restriction settings 61, No. 62, a product species 63, an upper limit of the number of wins 64, a blacklist 65, multiple wins of the same user 66, restriction on duplicated winning with another prize 67, and the like are displayed.

The prize set in step S24 is displayed in No. 62 and the product species 63 of the duplicated winning restriction settings 63. When a predetermined prize is selected in the blacklist 65, the setting column of a blacklist 70 is displayed for the selected prize, and the blacklist settings can be performed. The administrator can search for a user to be registered in the blacklist in a user search 71 and add the user to a blacklist user 73 by pressing an icon 72. By recording in advance that there has been an illicit act in association with the user ID, the user may be displayed in the column of the blacklist 70. In addition, the fact that a notification has been received from the operator of the event or a detail of the act may be recorded in association with the user ID, and the blacklist may be set with reference to the record. The blacklist user 75 can be deleted from the list by pressing a deletion icon. As the blacklist settings, the same blacklist may be applied to all the prizes selected in the blacklist 65, or the blacklist may be set for each prize. In addition, in a case where the winning probability of the lottery is decreased or increased, a predetermined probability to be decreased or increased can be input.

In the multiple wins of the same user 66, the same user can be set not to win the selected prize a plurality of times (can win only one time). That is, when the multiple wins of the same user 66 is not selected, the same user may win the prize a plurality of times. In the restriction on duplicated winning with another prize 67, it is possible to forbid duplicated winning with the selected prize. For example, when the B prize of 2 is selected as the restriction on duplicated winning of the A prize, the user who has won the A prize cannot win the B prize. On the other hand, the user who has won the B prize cannot win the A prize. That is, it is possible to select two or more benefits and perform control such that only one of the selected benefits is won. Note that, for the prize for which there is no upper limit of the number of wins, it is preferable that the blacklist settings, the multiple wins of the same user, the restriction on duplicated winning cannot be selected.

In a case where a plurality of application courses is set in FIG. 8, the column of the application course name 58 is displayed for each application course similarly in FIG. 10, and similar input processing as the restriction on duplicated winning 63 in the column of the application course name 50 described above can be performed. In addition, in the benefit information setting screen 100, the icons 41 to 43 are displayed as in FIG. 8.

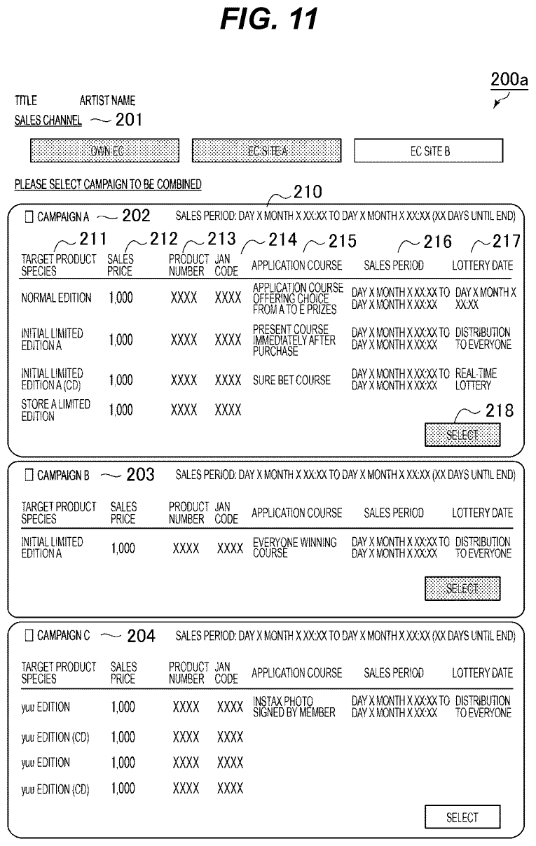

FIG. 11 is a diagram illustrating an example of the display screen of the administrator terminal according to the embodiment of the present invention. FIG. 11 illustrates the display screen when executing the input for the sales project design in step S3. When the product title or the product species is selected from the screen listing the product titles or the product species on which the processing in step S1 has been executed, by the operation input to the administrator terminal 1, a sales project design screen 200a in FIG. 11 is displayed.

On the sales project design screen 200a, the product title and the artist name related to the selected product title or product species are displayed. A sales channel 201 and campaigns 202 to 204 are also displayed. The displayed campaigns 202 to 204 are preferably all the set benefit information for the product species included in the selected product title. In addition, in a case where a specific product species is selected, the displayed campaigns are preferably all the set benefit information for the product species. Alternatively, the displayed campaign may be the benefit information that satisfies a predetermined condition. For example, the displayed campaign may be a campaign in which the release period of the campaign or the application course associated with the benefit information is scheduled on a future date or has not ended yet.

In the campaigns 202 to 204, a release period 210 of the campaign, a target product species 211, a sales price 212 of the product, a product number 213, a JAN code 214, an application course 215, a sales period 216 of the application course, a lottery date 217, an icon 218, and the like are displayed. The target product species 211 is a product species stored in association with the campaign 202. That is, the target product species 211 is a product species stored in association with the benefit information. The JAN code 214 is the identification number of a product common to the world, and indicates which product of which company. The application course 215 displays the application course included in the benefit information.

The administrator selects the sales channel 201 for the sales product by the operation input to the administrator terminal 1. One or a plurality of sales channels may be selected. In addition, the benefit information to be combined is selected from the campaigns 202 to 204. One or a plurality of pieces of benefit information may be selected. By pressing the icon 218, the benefit information can be selected. Hereinafter, a case will be described in which an own EC and an EC site A are selected as the sales channel, and the sales product obtained by combining campaigns A and B is set.

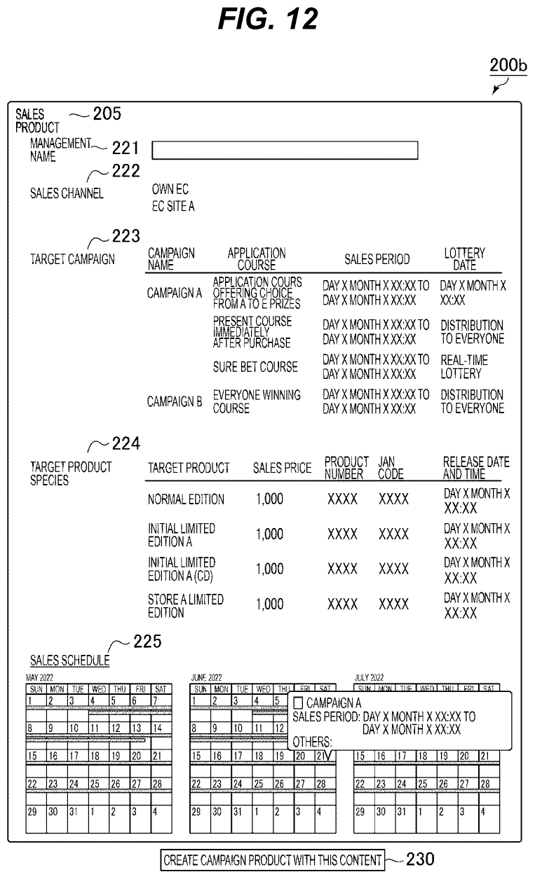

When the administrator selects the own EC and the EC site A as the sales channel and selects the campaigns A and B by the operation input to the administrator terminal 1, the display screen in FIG. 12 is displayed. FIG. 12 is a diagram illustrating an example of the display screen of the administrator terminal according to the embodiment of the present invention.

On a sales project design screen 200b, the information of a sales product 205 is displayed. Specifically, a management name 221, a sales channel 222, a target campaign 223, a target product species 224, a sales schedule 225, and the like are displayed. The name of a product group in which the target product species to be sold are collected can be input to the management name 221. The target campaign 223 displays the benefit information included in the product group. Here, among a normal edition, an initial limited edition A, an initial limited edition A (CD), and a store A limited edition, the initial limited edition A is combined with the campaigns A and B, and another product species is combined with the campaign A. For the target product species 224, the campaign to be combined may be displayed in the vicinity of the product species so that the campaign that will be combined therewith can be known.

In a case where there may be a plurality of combinations of the product species and the benefit information, one product in which the most pieces of benefit information is combined with the product species may be set. Alternatively, a plurality of different products may be set for each possible combination of the product species and the benefit information. That is, in the above case, the initial limited edition A, which is the product species, can be set as different sales products for three patterns of combinations of the benefit information including only the campaign A, only the campaign B, and the campaigns A and B. Which combination of products is to be selected can be selected by the operation input to the administrator terminal 1. Alternatively, a condition of product setting in which a product with which the most pieces of benefit information are combined is set may be stored in advance in the content server 3.

In the schedule 225, the sales period is displayed for each benefit information displayed in the target campaign 223. Each sales period of the application course may be displayed on a calendar. Note that the sales product can continue to be sold even after the sales period of the benefit information has elapsed, but the benefit information cannot be used by purchasing the sales product. Alternatively, the sales period of the benefit information may end at the same time as the sales period of the sales product.

By pressing an icon 230, the administrator can create the sales product for the product species displayed on the sales product 205. When the sales product is created, the product identification information is issued for each sales product, and the content information or the content ID and the benefit information or the benefit ID combined together are stored in the content server 3 in association with the product identification information.

### Flow of Sales System

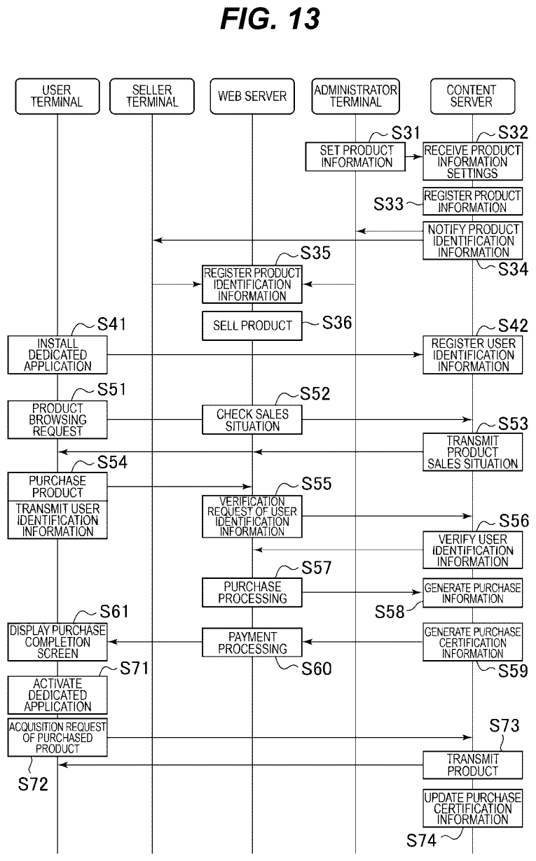

Next, a processing flow of the sales system according to the embodiment of the present invention will be described. FIG. 13 is a diagram illustrating the processing flow of the sales system according to the embodiment of the present invention.

First, a processing flow related to product registration will be described. First, the product information is set by the input to the administrator terminal 1 (step S31). Information regarding the input product information settings is transmitted from the administrator terminal 1 to the content server 3 and received by the content server 3 (step S32). The product information and the product identification information are registered in the content server 3 (step S33). The processing in steps S31 and S32 corresponds to the processing in steps S1 to 3, and the processing in step S33 corresponds to the processing in step S4. When the product information and the product identification information are registered in the content server 3, a notification indicating that the product identification information is registered is transmitted from the content server 3 to the administrator terminal 1 and/or the seller terminal 2 (step S34).

Next, the product identification information is registered in the web server 4 by the input to the administrator terminal 1 and/or the seller terminal 2 (step S35). As a result, the product can be sold in the web server 4 (step S36). In addition, since the product information can be specified by the product identification information, the product having the same product information can be sold in the plurality of web servers 4. That is, the same product can be sold on a plurality of EC sites. Note that step S34 may be omitted. In this case, when step S33 is performed, the product identification information may be transmitted from the content server 3 to the web server 4 corresponding to the sales channel associated with the product information, and the processing in step S35 may be performed.

Here, a processing flow related to registration of the user identification information capable of identifying the user information related to the user will be described. The user downloads the dedicated application to the user terminal 5 (step S41). At this time, the user performs user registration. As the user registration, a name, a nickname, a user ID, an e-mail address, a password, a date of birth, a prefecture, and the like are input. The input user information is transmitted to the content server 3 together with identification information (also referred to as terminal-unique identification number; for example, UDID) capable of identifying the user terminal 5 used by the user. The identification information of the user terminal 5 and the input information are stored as the user information in association with each other in the content server 3, whereby the user identification information is registered (step S42). The user identification information may be the user ID. That is, the user and the user terminal 5 can be specified from the user identification information. As a result, when the dedicated application is activated, the identification information of the user terminal 5 is transmitted from the user terminal 5 to the content server 3, and the user is specified, so that the user can skip the login operation of the dedicated application. Note that the user information and the user identification information are preferably encrypted and stored in the content server 3.

Next, a processing flow related to product sales will be described. The user browses a product to be purchased on the EC site. A product browsing request is transmitted from the user terminal 5 to the web server 4 by the user's operation input (step S51). The product browsing request includes the product identification information of the product. When the web server 4 receives the product browsing request, the web server 4 transmits a checking request for the current sales situation of the product to the content server 3 (step S52). The checking request includes the product identification information of the product. The sales situation is information that serves as a determination factor regarding purchase by the user. For example, in a case where the number of products to be sold is limited, the sales situation is the number of remaining purchasable products. In a case where the upper limit of the number of wins is set for the benefit information, the sales situation is the number of yet-to-be-won products at present. In a case where the sales period or the application period is set for the product, the sales situation is whether the sales period or the application period has elapsed by now.

When the content server 3 receives the checking request for the sales situation of the product, the content server 3 specifies the sales situation of the product corresponding to the product identification information, and transmits the sales situation to the web server 4 (step S53). When the web server 4 receives the sales situation of the product, the information is transmitted to the user terminal 5 and displayed on the user terminal 5. In a case where the user purchases the product, a product purchase request is transmitted from the user terminal 5 to the web server 4 by the operation input to the user terminal 5 (step S54). The product purchase request includes the product identification information of the product. At this time, the user identification information is transmitted from the user terminal 5 to the web server 4. When the web server 4 receives the product purchase request and the user identification information, the web server 4 transmits a verification request of the user identification information to the content server 3 (step S55). The verification request includes the product identification information of the product and the user identification information.

When the content server 3 receives the verification request of the user identification information, the content server 3 verifies the user identification information, and transmits the verification result to the web server 4 (step S56). The verification of the user identification information refers to verifying whether or not the received user identification information exists in a database of the user identification information stored in the content server 3. In a case where the information matches the user identification information stored in the database of the content server 3 as a result of verification, the web server 4 executes purchase processing (step S57). When the purchase processing is executed, the content server 3 generates purchase information regarding purchase (step S58), and further generates purchase certification information (step S58). The purchase information stores, for example, the product identification information corresponding to the purchased product, the number of purchased products, a purchase time, and the like. The purchase certification information is information in which the purchase information is associated with the user identification information, and is information indicating that the user who has purchased the product is the owner of the purchased product. The purchase certification information may not be generated when the user identification information does not exist in the database of the content server 3. At this point of time, the ownership is owned by the content server 3. When payment processing is executed by the web server 4 (step S60), a purchase completion screen is displayed on the user terminal 5 (step S61).

In a case where the user identification information does not match the user identification information stored in the database of the content server 3 as a result of verification of the user identification information, the purchase processing is not performed, and a request to perform the processing in steps S41 and S42 is displayed in the user terminal 5. Alternatively, the purchase processing is executed, and the purchase information and the identification information of the user terminal 5 are stored in association with each other without generating the purchase certification information in step S59. After the processing in steps S41 and S42 is executed, the user who has purchased the product may be specified from the identification information of the user terminal 5, and the content server 3 may generate the purchase certification information.

When the user activates the dedicated application after purchasing the product (step S71), an acquisition request of the purchased product is transmitted from the user terminal 5 to the content server 3 (step S72). At this time, the user identification information or the identification information of the user terminal 5 is transmitted from the user terminal 5 to the content server 3. The content server 3 specifies the purchase certification information from the user identification information or the identification information of the user terminal 5, specifies the product identification information corresponding to the purchased product, and further specifies the product information. In addition, the content information and the benefit information are specified from the product information. The product corresponding to the specified product information is transmitted from the content server 3 to the user terminal 5 (step S73). Specifically, the content information and/or the benefit information specified by the product information is transmitted to the user terminal 5. In step S73, the purchased product becomes available in the user terminal 5.

Specifically, that the product of the purchased product becomes available means that the page of the product corresponding to the product information is created in the user terminal 5, and downloading of the content information, application to a lottery for the benefit included in the benefit information, and the like become possible. In step S73, the content information and the benefit information corresponding to the purchased product specified by the product information may be transmitted simultaneously, or may be transmitted at different timings. The content information and the benefit information may be transmitted to the user terminal 5 according to the operation input to the user terminal 5. In addition, after the product is transmitted, the content server 3 updates the purchase certification information (step S74). In the update of the purchase certification information, the purchased product is transmitted to the user who has purchased the product, and that the ownership has been substantially transferred from the content server 3 to the user is registered.

Note that the purchase certification information may be recorded in a blockchain. Examples of the information to be recorded in the blockchain include a sales channel ID, a sales channel store ID, a user ID, and the amount of money of the sales product, in addition to the purchase certification information. In addition, an identification number (also referred to as token) stored in association with the purchased product may be assigned as the purchase certification information. The token is a unique identification number associated with one product, and is given every time the product is purchased. That is, even when the same products are purchased, the token of the first purchased product is different from the token of the second purchased product. In addition, a serial code may be assigned as the token. As the token of the product, a NFT (non fungible token) may be given. As a result, the ownership of the product can be proved, and falsification of the product information can be prevented. Note that the token stored in association with the purchased product is information different from the product identification information capable of specifying the product information.

Note that the processing in steps S51 to S53 may be omitted. In addition, the processing in steps S41 and S42 may be executed at any timing before step S54. Moreover, the processing in steps S52 and S53 may be performed during the processing in step S55. Specifically, for the product for which the product purchase request has been received by the web server 4, the checking request for the sales situation of the product is transmitted from the web server 4 to the content server 3. When the content server 3 receives the checking request for the sales situation of the product, the content server 3 specifies the sales situation of the product and transmits the sales situation to the web server 4. The sales situation is the same information as described above. For the sales situation specified by the content server 3, for example, in a case where the stock quantity of the product is zero, the purchase processing in step S57 is not executed, and the fact is transmitted from the web server 4 to the user terminal 5. That is, the processing in step S57 is executed only when the product is in stock.

Here, the sales system described above can be divided into the first system and the second system. Specifically, assuming that steps S54 and S55 are the first system and step S73 is the second system, the first system may include an identification information transmitter that transmits the user identification information capable of identifying the user or the user terminal and the product identification information capable of identifying the product to the second system in association with each other according to the operation on the user terminal operated by the user, and the second system may include an identification information receiver that receives the user identification information and the product identification information, and a product information transmitter that transmits the product (for example, the content information and the benefit information) corresponding to the product identification information associated with the user identification information to the user terminal operated by the user corresponding to the received user identification information or the user terminal corresponding to the received user identification information.

Although the processing in steps S51 to S61 has been described for a case where the product is purchased online, the system of the present invention can be applied to the product purchased in an actual store as long as the product has the product identification information. In this case, it is preferable that a serial code functioning as the product identification information capable of identifying the product information is attached to the product sold in an actual store.

In this case, the serial code is read by inputting the serial code attached to the product, photographing a two-dimensional code indicating the serial code by the camera of the user terminal 5 being activated, or selecting a photograph obtained by photographing the two-dimensional code indicating the serial code. The information of the read serial code is transmitted to the content server 3. When the content server 3 specifies the corresponding product information from the received information, the processing in step S73 is executed. In addition, the processing in steps S58, S59, and S74 may be performed.

Note that the product transmitted from the information read from the actual product may have different detail from the product to be purchased from the EC site. For example, restriction may be imposed on the content download or the GIFT sending function. In addition, the transmission of the product from the content server 3, which is executed by reading the serial code, may be executed only by reading the serial code for the first time. That is, in the second and subsequent reading of the serial code, the product is not transmitted. Specifically, when the content server 3 receives the information of one serial code, the content server 3 specifies the corresponding product, and transmits the specified product to the user terminal 5. On the other hand, a configuration may be adopted in which the specified product is not transmitted from the content server 3 to the user terminal 5 even when the content server 3 receives the information of the one serial code twice or more. This makes it possible to prevent more pieces of content information and benefit information than the number of purchased products from being transmitted to the user.

In addition, the content server 3 may include an identification information receiver that receives the user identification information capable of identifying the user or the user terminal and the product identification information capable of identifying the product in association with each other according to the operation on the user terminal, and a product information transmitter that transmits the product corresponding to the product identification information associated with the user identification information to the user terminal operated by the user corresponding to the received user identification information or the user terminal corresponding to the received user identification information.

### Sales Management

In the embodiment of the present invention, personal information such as a name, a date of birth, a residence prefecture, and gender can be registered as the information of the user in the dedicated application. These pieces of information are also referred to as user type. In addition, the number of products purchased, the date of purchase, the presence or absence of content download, information regarding the benefit, information regarding the lottery, and information regarding the GIFT are stored in the content server 3. Therefore, the administrator can aggregate and display various types of information regarding the product on the administrator terminal 1. For example, it is possible to manage the number of products sold as a whole, the number of products purchased per person, the date of purchase of a product, the number of times content has been downloaded in the dedicated application, the number of times a downloadable benefit has been downloaded, the number of applications to a predetermined prize, the number of times a user has sent the GIFT, the number of times a person who has been gave the GIFT has used the content, the age, gender, residence, and the like of the user who has purchased the product. This makes it possible for the administrator to easily administrate the sales situation. In addition, the administrator can easily check the correlation between the event and the number of products sold.

In addition, in the embodiment of the invention described above, the configuration for downloading the content has been described, but the content may be acquired by streaming.

According to the present invention, since it is possible to generate the product information capable of specifying the product including a combination of the selection-received content information and the selection-received benefit information, it is possible to easily generate a plurality of products with variations. In addition, the administrator or the like can flexibly distribute the benefit information in various modes to the users. Therefore, it is possible to increase the user's satisfaction and desire of purchase. Moreover, according to the present invention, since the content information and the benefit information corresponding to the generated product can be transmitted to the user terminal, the product can be sold without creating a real product. This makes it possible to reduce environmental load. Furthermore, a conventional problem is eliminated in which many CDs are purchased and then discarded, which makes it possible to provide a system having no environmental load.

In addition, according to the present invention, it is possible to select a specific user and change a winning probability of the benefit of the selected user, so that the event can be smoothly operated. Moreover, according to the present invention, the user identification information capable of identifying the user or the user terminal and the product identification information capable of identifying the product can be associated with each other, so that the same product can be provided on a plurality of websites. In addition, according to the present invention, since the digital benefit can be distributed by setting a predetermined time, the campaign can be conducted with a time limit. Furthermore, according to the present invention, since the admission ticket and/or the benefit ticket for the event is/are managed using the user ID associated with the user terminal, it is possible to prevent the admission ticket and/or the benefit ticket from being illegally transferred to another user terminal. Therefore, it is possible to prevent resale of the admission ticket and/or the benefit ticket. In addition, according to the present invention, since the product can be distributed online, it is not necessary to control the stock and physical distribution of real products.

Reference Signs List

| | | | |
|---|---|---|---|
| 1, 1a~1z | administrator terminal | 2 | seller terminal |
| 3 | content server | 4, 4a~4z | web server |
| 5, 5a~5z | user terminal | 6 | communication |
| | | | network |
| 11 | control unit | 12 | main memory |
| 13 | storage | 14 | input device |
| 15 | display device | 16 | communication |
| | | | interface |
| 21 | control unit | 22 | main memory |
| 23 | storage | 23 | communication |
| 100a~100c | benefit information | | interface |
| | setting screen | | |
| 200a, 200b | sales project design | | |
| | screen | | |
| 201 | sales channel | 202~204 | campaign name |
| 205 | sales product | 211 | target product |
| | | | species |
| 212 | sales price | 213 | product number |
| 214 | JAN code | 215 | application course |
| 216 | sales period | 217 | lottery date |
| 218 | icon | 221 | management name |
| 222 | sales channel | 223 | target campaign |
| 224 | target product species | 225 | sales schedule |
| 230 | icon | | |
| 30 | application course | | |
| | settings | | |
| 31 | application course name | 32 | application method |
| 33 | lottery method | 34 | application period |
| 35 | expected number of | | |
| | applications | | |
| 36 | prize designation/non- | | |
| | designation | | |
| 301 | No. | 302 | target product |
| | | | species |
| 303 | target selection | 304 | category |
| 305 | product number | 306 | price |
| 307 | condition mapping | 308 | acquisition |
| | | | condition |
| 40~43 | icon | 50 | application course |
| | | | name |
| 51 | icon | 52 | description |
| 53 | prize name | 54 | category |
| 55 | upper limit | 56 | edit |
| 57 | icon | 58 | application course |
| | | | name |
| 61 | duplicated winning | | |
| | restriction settings | | |
| 62 | No. | 63 | product species |
| 64 | upper limit of the number | | |
| | of wins | | |
| 65 | blacklist | | |
| 66 | multiple wins of the | | |
| | same user | | |
| 67 | restriction on duplicated | | |
| | winning with another | | |
| | prize | | |
| 70 | blacklist | 71 | user search |
| 72 | icon | 73 | blacklist user |

1. A system comprising at least one computer apparatus, the system comprising:
a content information storage that stores at least one piece of content information;
a benefit information storage that stores at least one piece of benefit information;
a content information selector that receives selection of the at least one piece of content information stored in the content information storage by an operation on a first user terminal operated by a first user;
a benefit information selector that receives selection of the at least one piece of benefit information stored in the benefit information storage by an operation on the first user terminal; and
a product information generator that generates product information capable of specifying a combination of the selection-received content information and the selection-received benefit information.

2. The system according to claim 1, comprising
a product information transmitter that transmits the content information and the benefit information specified by the generated product information to a second user terminal operated by a second user by an operation on the second user terminal.

3. The system according to claim 1, comprising
a benefit information generator that generates benefit information by an operation on the first user terminal, wherein
the benefit information storage stores the generated benefit information.

4. The system according to claim 1, wherein the product information generator generates a plurality of pieces of product information capable of specifying a combination of one piece of content information with each of different types and/or different numbers of pieces of benefit information.

5. The system according to claim 1, wherein the content information is music information, audio information, image information, moving image information, and/or character information.

6. The system according to claim 1, wherein the benefit information is information regarding an admission ticket or a benefit ticket for an event regarding the content information, information regarding merchandise regarding the content information, and/or audio information, moving image information, or image information regarding the content information.

7. The system according to claim 1, wherein the benefit information includes lottery information for drawing a benefit to be granted to the second user.

8. The system according to claim 7, wherein the lottery information enables a lottery to be drawn according to the number of times of purchasing a product including a combination of the content information and the benefit information, an amount of money of purchasing the product, and/or a combination of purchased products.

9. A method executed in a system including at least one computer apparatus, the method comprising:
first storing at least one piece of content information;
second storing at least one piece of benefit information;
first receiving selection of the at least one piece of content information stored in the first storing by an operation on a first user terminal operated by a first user;
second receiving selection of the at least one piece of benefit information stored in the second storing by an operation on the first user terminal; and
generating product information capable of specifying a combination of the selection-received content information and the selection-received benefit information.

10. (canceled)

11. (canceled)

12. The system according to claim 1, comprising a plurality of a first system including at least one computer apparatus, and a second system including at least one computer apparatus,
the first system including
an identification information transmitter that transmits a second user identification information capable of identifying a second user or a second user terminal and product identification information capable of identifying a product to the second system in association with each other according to an operation on the second user terminal operated by the second user, and
the second system including
an identification information receiver that receives the second user identification information and the product identification information, and
a product information transmitter that transmits the product information corresponding to the product identification information associated with the second user identification information to the second user terminal operated by the second user corresponding to the received second user identification information or the second user terminal corresponding to the received second user identification information when the second user identification has been stored in a database of the second system.

13. (canceled)

14. (canceled)

15. The system according to claim 1, comprising:
a reader that reads product identification information capable of identifying a product at a second user terminal operated by a second user;
an identification information receiver that receives second user identification information capable of identifying a second user or a second user terminal and the product identification information read in the reader in association with each other according to an operation on the second user terminal; and
a product information transmitter that transmits product information corresponding to the product identification information associated with the second user identification information to the second user terminal operated by the second user corresponding to the received second user identification information or the second user terminal corresponding to the received second user identification information.

16. (canceled)

17. The system according to claim 1, comprising
a purchaser that executes purchase processing of the content information and the benefit information by selection a product corresponding to the product information by an operation on a second user terminal operated by a second user.

18. The system according to claim 1, wherein
the benefit information storage stores at least one piece of the benefit information and at least one piece of the content information in association with each other, the system comprising
displayer that controls to display the benefit information associated with the selection-received content information by the content information selector in the first user terminal, wherein
the benefit information selector receives selection of the at least one piece of benefit information displayed by the displayer by an operation on the first user terminal,
the product information generator generates the product information capable of specifying a combination of the selection-received benefit information in the benefit information selector and the content information associated with the benefit information

19. The system according to claim 1, comprising
a channel selector that receives selection of a channel that sells a product by an operation on the first user terminal, wherein
the product information generator generates the product information capable of specifying a combination of the selection-received content information, the selection-received benefit information and the selection-received channel.

20. The system according to claim 15, comprising
a certification information generator that generates a purchase certification information recorded in a blockchain and indicating an owner of the product corresponding to the product identification information, associated with the received second user identification information.

21. The system according to claim 15, comprising
a controller that controls not to transmit the product information corresponding to one product identification information when the one product identification information received again in the identification information receiver.
